(19) United States
(12) Patent Application Publication
(10) Pub. No.: US 2016/0183726 A1
(43) Pub. Date: Jun. 30, 2016

(54) DISPOSABLE GRILLING SET

(71) Applicant: Gil Mong HONG, Seoul (KR)

(72) Inventor: Gil Mong HONG, Seoul (KR)

(21) Appl. No.: 14/909,258

(22) PCT Filed: Jul. 30, 2014
(86) PCT No.: PCT/KR14/06982

§ 371 Date: Feb. 1, 2016

(30) Foreign Application Priority Data
Aug. 2, 2013 (KR) 10-2013-0091860

(51) Int. Cl. A47J 37/07

(52) U.S. Cl. CPC A47J 37/0768

(57) ABSTRACT

The present invention relates to a disposable griller set which can be simply and easily used outdoors and more particularly to a disposable griller set which enables comsumers to simply and easiy grill food such as meat or fish without need for a separate heating means. The disposable griller set of the present invention stores charcoal, a grilling plate, and solid fuel for lighting the charcoal fire inside the insulation-coated paper case therein so as to enable the same to be simply and easily taken out and used, and thus manufacturing is easy due to the simple structure thereof. In addition, since the case is made from paper, the support plate of the brazier is made from metal, and the brazier and grilling plate are made of a thin sheet of aluminum. Each of these elements can be easily separated and recycled at the time of disposal.

### TECHNICAL FIELD

The present invention relates to a disposable griller set which can be simply and easily used outdoors and more particularly to a disposable griller set which enables comsumers to simply and easiy grill food such as meat or fish without need for a separate heating means.

### BACKGROUND ART

Currently, in accordance with the improvement in the standard of living, the camping population enjoying outdoors is increasing exponentially, and the use of auto camping using a car is also spreading gradually.

Thus, a variety of grillers capable of simply and easiy grilling meat or fish around outside have been developed.

As the grilling method which has been conventionally used, a grilling method using a portable gas stove, a method of lighting charcoal, putting a gridiron thereon and performing the grilling, a grilling method using Bongetan (disposble charcoal) and the like are mainly used.

The above method using a portable gas stove is a method where a hot grill is placed on the top of a portable gas stove and performing the grilling and has an advantage that the firepower can be easily controlled by using a gas fire.

However, the above method has an uncomfortable disadvantage because a portable gas stove, a butane gas fuel and a hot grill have to be prepared, and cleaning and storage after use are necessary.

The above grilling method using charcoal fire needs charcoal fuel, a grilling device that the charcoal can be put into, and a gridiron. Thus, there are disadvantages in that the volume of the charcoal fire grilling device is large; the cost is high; difficulty in lighting up the charcoal fire; and fats, spices or the like drip on the burning charcoal fire during use and thus smoke which is harmful to the human body is generated while incomplete combustion is made. Further, there is a problem that cleaning and storage after use is cumbersome.

On the other hand, the grilling method using Bongetan also has an inconvenient disadvantage that consumers must purchase a grilling device, a grilling plate and Bongetan in detail. Also, this method has the same inconveniences and problems as the charcoal fire griller. In particular, since Bongetan contains a chemical component in the preparation process, it is known that chemicals such as benzopyrene, a carcinogen fatally harmful to the human body, are produced when fats, spices or the like of the grilled materials drop on the Bongetan during use, thus making incomplete combustion.

The conventional methods as described above have inconvenient problems that consumers must carry essentially devices capable of basically grilling, fuels capable of supplying a heat, grilling plates capable of supporting a grilling food, and the like.

In addition, in the conventional methods, the grilling devices must be manually cleaned and stored one by one after use, and thus the working is inconvenient and long time is required.

On the other hand, in order to solve the above-mentioned problems, a disposbale charcoal fire grilling device (Korean Utitlity Model Publication No. 20-0401798 published on Nov. 22, 2006) and a disposable charcoal fire griller set (Korean Utitlity Model Publication No. 20-2008-0006409 published on Dec. 19, 2008) have been devised.

The above-mentioned disposbale charcoal fire grilling device is configured such that a hot grill with a mesh structure is seated on the top of the device, a charcoal is housed in a case made of a refractory material that is provided with one or more inflow holes, the meat seated over the hot grill is heated and roasted while the charcoal housed in the case is ignited and combusted, a step structure is formed to the upper frame of the case, a hot grill of a mesh structure is seated on the upper frame of the step structure; and the upper frame edge of the step structure that the hot grill of the mesh structure is seated on is folded in the inside to cover and fix the frame edge of the hot grill having the mesh structure.

However, the above-mentioned charcoal fire griller has a convenient effect because it can be discarded after one time use. However, since the grilling plate is made of a mesh, there is a disadvantage in that, when the meal is put and heated on the grilling plate, the oil generated from the meat drips on the charcoal fire and generates ashes and smokes. For this reason, there is a problem that soots and ashes harmful to the human body are adhered to the meat, which is unsanitary.

In addition, the above-mentioned method has problems in that it is difficult and hard to light a fire with the charcoal contained in the inside of the case and long time for the working is required.

### PRIOR ART LITERATURE

(Patent Document 1) Korean Utility Model Registration No. 20-0401798 (published on Nov. 22, 2006)

(Patent Document 2) Korean Utility Model Publication No. 20-2008-0006409 (published on Dec. 19, 2008)

### DISCLOSURE OF INVENTION

### Technical Problem

An object of the present invention is to solve the above-mentioned problems of the related prior arts and to easily light a fire with a charcoal contained in a disposable griller.

Another object of the present invention is to prevent the generation of smoke when heating meals with the disposable griller.

A further object of the present invention is to reinforce the strength of the grilling plate.

### Technical Solution

In order to achieve the above objects, the present invention provides a disposable griller set which comprises:

a paper case 1 in which a seating portion 15 is formed such that a perforated line 2 is formed on the upper surface and torn off, an air inflow hole 5 is formed in the front and back and both side faces of the case, a storage unit 4 is formed in the inside of the case, and an opening/closing portion 3 is formed so as to be folded and assembled in the front surface;

a solid fuel laying stand 7 which is inserted in the inside of the case 1 and formed of a seating groove 6 in the central portion, thus inserting a solid fuel storage basket 8 which stores solid fuel;

a brazier support 9 which is put on the top of the solid fuel laying stand 7 and stored inside the case 1, and which is formed of a brazier insertion hole 10 in the middle portion of the protrusion protruded to the top so that the brazier 11 can be put on the internal middle portion;

a brazier 11 which is inserted and fixed into the insertion hole 10 formed in the brazier support 9, and formed of a protrusion which is folded from the inside lower end to the upper side, in which a support plate 12 formed of a through hole is inserted so that air can be moved at a prescribed interval on the entire upper surface to the protrusion, and charcoal 13 is built-in the upper surface of the support plate 12; and

a grilling plate 14 which is put and assembled on the top of the brazier support 9 built-in the brazier 11, inserted and held in a storage portion 4 formed in the inside of the case 1 together with the brazier support 9 and then drawn out together with the brazier support 9, and seated and assembled in a seating portion 15 made by tearing a perforated line 2 formed on the top of the case 1.

The above case 1 is composed of a paper material, but the storage portion 4 is preferaly coated with an insulating material which blocks or reflects heat.

The above griller 14 is configured such that the central portion is closed, the peripheral portion is formed of a long hole 17 passed through the protrusion, but the long hole 17 is compressed and formed from the upper side to the lower side, thereby rib 18 is formed in the lower surface of the long hole 17 to reinforce the strength of the griller 14.

In an example of the present invention, it is desirable to add a separate auxiliary charcoal to the inside of the case 1.

[Favorable Effects]

As described above, the disposable griller set of the present invention stores charcoal, a grilling plate, and a solid fuel for lighting the charcoal fire inside the insulation-coated paper case therein so as to enable the same to be simply and easily taken out under use, and thus manufacturing is easy due to the simple structure. In addition, since the case is made of a paper, the support plate of the brazier is made of metal, and the brazier and grilling plate are made of a thin sheet of aluminum. Each of these elements can be easily separated and recycled at the time of disposal.

Also, with the disposable griller set of the present invention, the charcoal fire can be simply and easily lit because solid fuel is built-in in the lower portion of the oven where the charcoal is put.

In addition, the disposable griller set of the present invention is configured such that since an air inflow hole is formed in the both side surfaces of the case coated with an insulating material, hot air present in the inside of the case is moved to the upper side of the griller due to a convection phenomenon when lighting charcoal, thereby increasing the thermal efficiency and minimizing the heat loss.

Accordingly, the disposable griller set of the present invention can be simply and easily used outdoors and, when discarding the grilling plate, it can be separated and recycled, and thus it is useful in recycling resources.

### DESCRIPTION OF DRAWINGS

FIG. 1 is a schematic exploded perspective view showing a state of overall separation in accordance with the present invention.

FIG. 2 is a schematic perspective view showing a state of use in which the griller is seated on the seating portion of the griller in accordance with the present invention.

FIG. 3 is a schematic sectional view showing a state of use in accordance with the present invention.

FIG. 4 is a schematic side sectional view showing a state in which the griller is housed inside the case in accordance with the present invention.

FIG. 5 is a main portion-enlarged sectional view showing the device for reinforcing the strength of the griller in accordance with the present invention.

FIG. 6 is a main portion-enlarged sectional view showing a state in which an insulating material is coated inside the case in accordance with the present invention.

### BEST MODE

Hereinafter, the preferred examples of the present invention will be described in detail with reference to the accompanying drawings.

However, in the description of the present invention, if it is determined that details of the related known function or configuration make the subject matter of the present invention unnecessarily obscure, a detailed description thereof will be omitted.

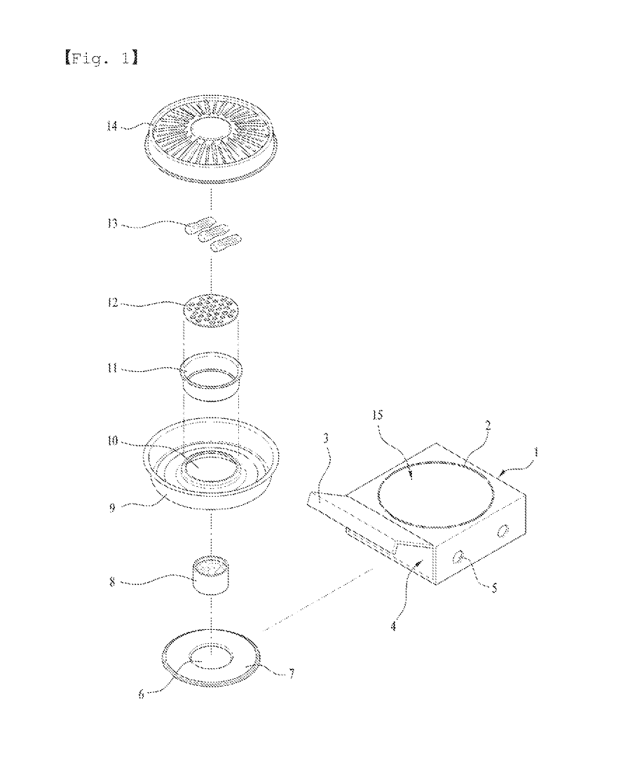

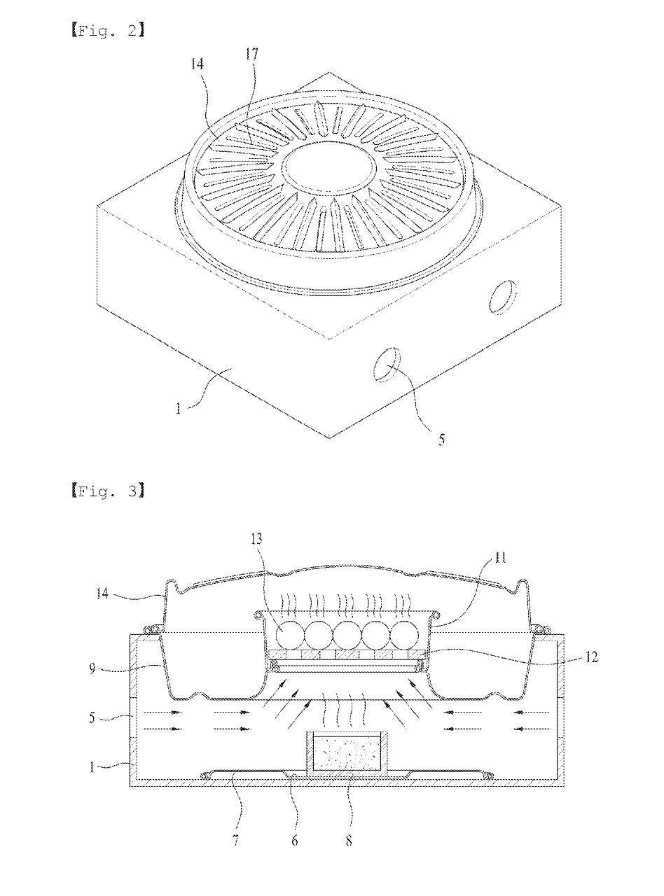

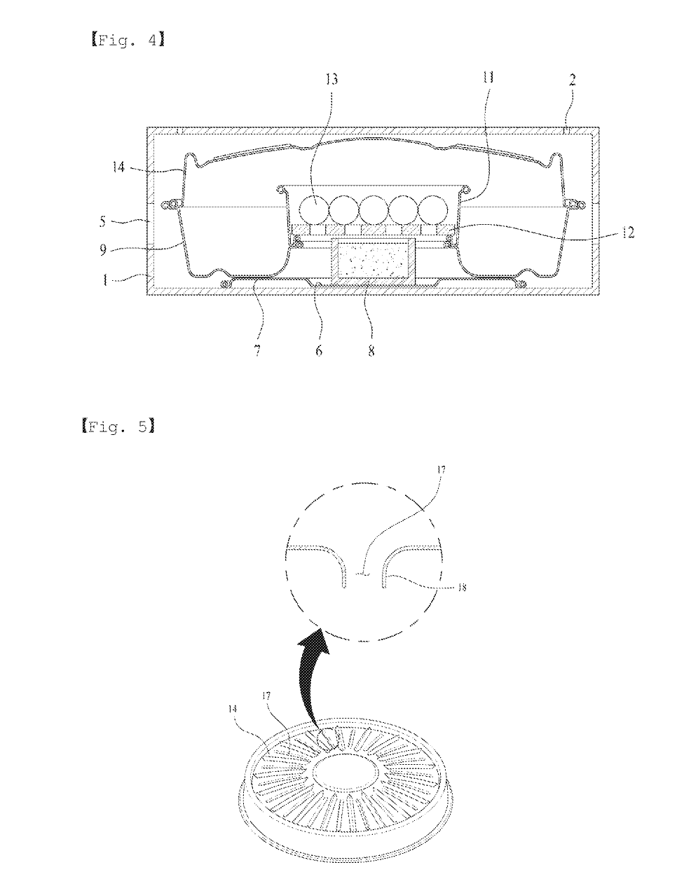

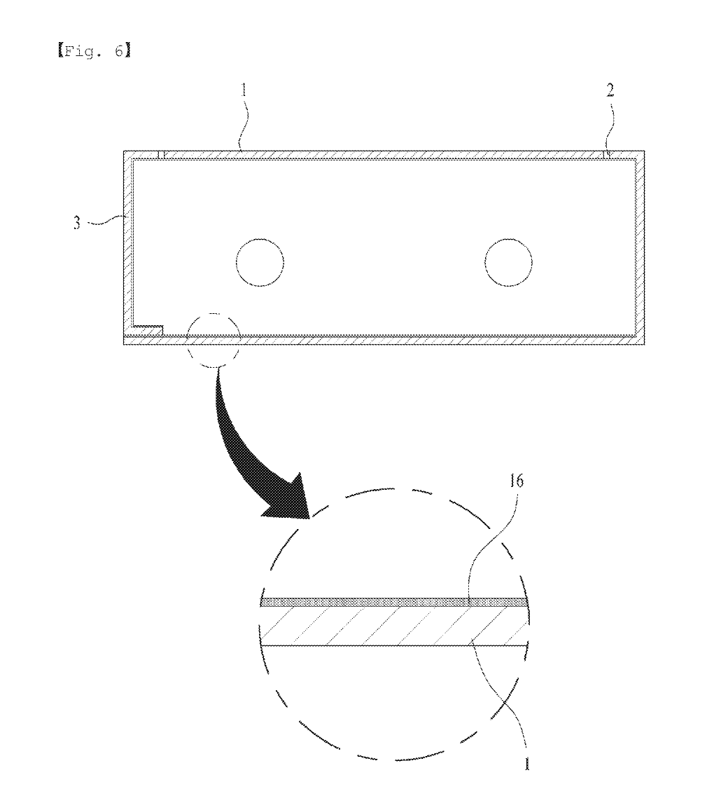

As shown in FIGS. 1 and 4, the opening/closing portion 3 formed on one side surface of the case 1 is folded and opened. In this case, the opening/closing portion 3 can be opened by expanding it to the upper side while pulling it to the outside because the case 1 constituiting the opening/closing portion 3 is made of a paper material.

In this state, a solid fuel basket 8 containing a solid fuel is put on a seating groove 6 which is formed in the central portion of the solid fuel laying stand 7 and formed on the top of a solid fuel laying stand 7.

The brazier support is put on the top of the solid fuel laying stand 7 on which the solid fuel is put. However, the brazier 11 is inserted into the internal central portion of the brazier support 9, the support plate 12 is inserted into the inside of the brazier 11 and then the charcoal 13 is put on the upper portion of the support plate 12.

The brazier 11 that the charcoal 13 is built-in on is inserted in the brazier insertion hole 10 formed in the internal central portion of the brazier support 9 and then the grilling plate 14 is put on the top of the brazier support 9.

The solid fuel laying stand 7, the brazier support 9 and the grilling plate 14 laminated as described above are inserted in the internal storage portion 4 through the opening/closing portion 3 of the case 1 and then the opening/closing portion 2 is closed and sealed. In this state, the case 1 is packed.

When the grilling plate is desired to be used in the state described above, the packed case 1 is taken out and the opening/closing portion 3 formed on the side surface is opened. Then, the solid fuel laying stand 7, the brazier support 9 and the grilling plate 14 which are stored in a storage portion 4 are taken out.

In the state described above, the seating portion 15 is formed by tearing along a perporated line 2 formed on the upper surface of the case 1.

The brazier support 9 is put on the seating portion 15, and then the brazier 11 is placed on the brazier insertion hole 10 formed in the central portion of the brazier support 15. Further, the brazier is combined with the support plate 12 formed of a plurality of through holes vertically from the upper surface of the brazier. The charcoal 13 is put on the upper surface of the support plate 12 and then the grilling plate 14 is put and assembled on the upper side of the brazier support 9.

The seating portion 15 formed on the top of the case as described above is combined with the brazier support 9 and the grilling plate 14. Then, the solid fuel is lighted with fire through the opening/closing portion 3 in the internal central portion of the case 1. Next, the solid fuel laying stand 7 on which the solid fuel basket 8 is put is pushed and inserted in the central portion of the storage portion 4 through the opening/closing portion 3, and then the opening/closing portion 3 is closed.

The method of lighting the charcoal fire is one example, wherein light can be lit with solid fuel and inserted in the inside of the case 1 and then the brazier support plate 9, the brazier 11 and the grilling plate 14 are combined with the seating portion 15.

On the other hand, the internal storage portion 4 of the case 1 is coated with an insulating material 16 which protects the case 1 from heat, thereby protecting a paper case 1 from heat due to the charcoal 13 lighting a fire with the solid fuel.

When the brazier support plate 9 and the grilling plate 14 are combined with the seating portion 15 of the case 1 as described above, the solid fuel enables the charcoal to light a fire through a through hole of the support plate 12 combined with the lower end portion of the brazier 11.

Therefore, the heat which is in the inside of the case 1 is raised to the upper side on which the brazier 11 and brazier support plate 9 are placed due to the convection phenomenon and thus the brazier 9 and grilling plate 14 are heated in a short time.

Further, while a hot air moves to the upper side in the inside of the case 1 due to the convection phenomenon, a vacuum is generated inside the lower end portion of the case 1. Thereby, the outside air is inflowed through an air inflow hole 5 formed in the forth and back and both side faces of the case 1.

On the other hand, the grilling plate 14 is formed of a concave-convex portion, and the protrusion and the long hole 17 are formed at a prescribed interval in the entire outside of the concave-convex portion. Therefore, the problem that pan juice or oil generated while heating the meal dripping down on the charcoal fire to cause smoke is prevented.

Further, the long hole 17 is punched and prepared to the lower surface of the grilling plate 14 and rib 18 is generated on the bottom peripheral portion of the long hole 17, thereby reinforcing the strength of the grilling plate 14.

Specific embodiments in accordance with the present invention are described, but it is understood that various modifications and changes may be made to the invention without deviating from the scope and spirit of the present invention,

Accordingly, the scope of the invention is not intended to be limited to the described embodiments, but it shall be defined by the appended claims as well as those equivalent to the claims.

### DESCRIPTION OF REFERENCE NUMERALS

1: case
2: perforated line
3: opening/closing portion
4: storage portion
5: air inflow hole
6: seating groove
7: solid fuel laying stand
8: solid fuel basket
9: brazier support
10. brazier insertion hole
11: brazier
12. support plate
13: charcoal
14: grilling plate
15: seating portion
16: insulating material
17. long hole
18: rib

What is claimed is:

1. A disposable griller set which comprises:
a brazier support which is formed of a brazier insertion hole in a middle portion of a protrusion protruded to a top so that the brazier can be put on the internal middle portion;
a brazier which is inserted and fixed into the insertion hole formed in the brazier support, and formed of a protrusion which is folded from an inside lower end to an upper side, in which a support plate formed of a through hole is inserted so that air can be moved at a prescribed interval on the entire upper surface to the protrusion, and charcoal is built-in the upper surface of the support plate; and
a grilling plate which is put and assembled on the upper surface of the brazier support built-in the brazier,
characterized in that the griller set comprises:
a paper case in which a seating portion is formed such that a perforated line is formed on the upper surface and torn off, an air inflow hole is formed in the front and back and both side faces of the case, a storage unit is formed in the inside of the case, and an opening/closing portion is formed so as to be folded and assembled in the front surface;
a solid fuel laying stand which is inserted in the inside of the case and formed of a seating groove in the central portion, thus inserting a solid fuel storage basket which stores solid fuel; and
a grilling plate which is put and assembled on the top of the brazier support built-in the brazier, inserted and held in a storage portion formed in the inside of the case together with the solid fuel laying stand, the brazier, the charcoal, the solid fuel basket and the brazier support, and then drawn out, and seated and assembled in a seating portion made by tearing a perforated line formed on the top of the case.

2. The disposable griller set of claim 1 wherein the case is composed of a paper material, but the storage portion is coated with an insulating material which blocks or reflects heat.

3. The disposable griller set of claim 1 wherein the griller is configured such that the central portion is closed, the peripheral portion is formed of a long hole passed through the protrusion, but the long hole is compressed and formed from the upper side to the lower side, thereby the rib is formed in the lower surface of the long hole so as to reinforce the strength of the griller.
